(19) United States
(12) Patent Application Publication
(10) Pub. No.: US 2011/0246211 A1
(43) Pub. Date: Oct. 6, 2011

(54) JOB HISTORY COMPLEMENTING METHOD FOR EDI CUSTOMERS

(75) Inventors: HIDEYUKI KOBAYASHI, Hitachi (JP); Hirobumi Hashimoto, Tokyo (JP); Hiroyuki Hamada, Yokohama (JP)

(73) Assignee: Hitachi, Ltd.

(21) Appl. No.: 12/969,010

(22) Filed: Dec. 15, 2010

(30) Foreign Application Priority Data
Apr. 1, 2010 (JP) 2010-084793

(51) Int. Cl. G06Q 10/00

(52) U.S. Cl. 705/1.1

(57) ABSTRACT

To provide a method of complementing history information on a job, which has been performed by a company incapable of acquiring information on a level on which individual products can be discriminated from one another (hereinafter called an individual level), by utilizing business deal information, which is transferred through EDI (hereinafter called an EDI message) as long as one of two companies that make a business deal with each other through EDI can acquire job history information while discriminating the individual products from one another. In a turnaround deal to which an ID that uniquely specifies the deal is assigned (hereinafter called a deal number) in relation to a series of jobs that starts with ordering succeeded by shipment and receipt, testing, acceptance inspection, and payment, a job history is complemented by performing calculation on an individual level using a deal number as a key on the basis of EDI messages containing the deal number and job history information of the individual level acquired during any of the series of jobs. At this time, the number of records in the acquired job history information of the individual level is inconsistent with a value of a quantity acquired from the EDI message, a probability value or a virtual ID is used to complement the job history.

### BACKGROUND OF THE INVENTION

(1) Field of the Invention

The present invention relates to a technology for grasping a job history concerning products using an information processing technology. In particular, the present invention is concerned with a technology for complementing history information on a job, which has been performed by a company incapable of acquiring information on a level on which individual products can be discriminated from one another (hereinafter called an individual level), on the individual level by utilizing business deal information to be transferred through EDI.

(2) Description of the Related Art

In recent years, product recall has frequently occurred. When a defect is recognized in an own products of a manufacturer, the necessity of recall arises. After products are delivered to other company, if the necessity of recall is discovered, since history information on a job that involves companies is managed company by company, there is no other way for the manufacturer to query the company that is a shipping destination. Therefore, it is time-consuming to trace the location of the products to be recalled.

Under the circumstances, Japanese Patent Application Laid-Open Publication No. 2006-171805 has addressed an issue that it is necessary for two companies to construct a mechanism of discriminating individual products from one another, manage job history information, and enable search of the job history information in case a trouble such as recall occurs, and has disclosed an EDI system that handles fresh products as objects of tracing and that ensures traceability during distribution. Specifically, a center server has a database, business deal information that is transferred between the two companies and job history information are acquired into the database and managed comprehensively. Thus, history information on a job which has involved the two companies can be searched.

### SUMMARY OF THE INVENTION

However, when job history information is managed with individual products discriminated from one another, companies that make a business deal with each other through electronic data interchange (EDI) have to be able to acquire job history information on a level on which the individual products can be discriminated from one another (hereinafter called an individual level).

An object of the present invention is to provide a method that as long as one of two companies which make a business deal with each other through EDI can acquire job history information on an individual level, can complement history information on a job, which has been performed by the company incapable of acquiring information on the individual level, on the individual level by utilizing business deal information that is transferred through EDI.

In order to solve the aforesaid problem, according to the present invention, job history information signifying a history of each job involved in a deal made for individual products owned by one of companies (organizations) that have a business relationship, and an EDI message concerning the deal are used to complement job history information of the other company by compensating for information that has not been acquired. At this time, if data of a quantity concerning a deal specified in the job history information used for complementing and data of a quantity specified in the EDI message are inconsistent with each other, the data items and other data (for example, a probability value or a virtual ID) are used to estimate the job history information. This is also encompassed in an aspect of the present invention.

More particularly, the present invention includes constituent features described below. Assume that an ID that uniquely specifies a deal (hereinafter called a deal number) is assigned to a deal in relation to a series of jobs that starts with ordering succeeded by shipment and receipt, testing, acceptance inspection, and payment. In first information processing equipment including an arithmetic processing unit, a storage unit, and a communication unit, a first job history complementing method is implemented in order to complement history information on a job, which has been performed by a company incapable of acquiring information on a level on which individual products can be discriminated from one another (hereinafter called a individual level), on the individual level. The first job history complementing method includes: processing in which the arithmetic processing unit acquires job history information of the individual level, and business deal information (hereinafter called an EDI message), which is transferred between second information processing equipment and third information processing equipment through EDI, from the second information processing equipment via the communication unit; processing in which the arithmetic processing unit acquires an EDI message from the third information processing equipment via the communication unit; processing in which the job history is complemented by performing calculation on the individual level using the deal number as a key on the basis of the EDI messages containing the deal number, and the job history information of the individual level which is acquired during any of the series of jobs; and processing in which if the result of comparison of the number of records in the job history information with a value of a quantity acquired from the EDI message demonstrates that the number of records and the value are inconsistent with each other, the job history is estimated.

According to the present invention, there is provided a second job history complementing method in which the processing of estimating a job history included in the first job history complementing method includes processing in which if the result of the comparison demonstrates that the number of records in the job history information is larger, a probability value at which each of products corresponding to individual IDs specified in the job history information has existed during a job that has history information thereon complemented is calculated.

Further, according to the present invention, there is provided a third job history complementing method in which the processing of estimating a job history included in the first job history complementing method includes processing in which if the result of the comparison demonstrates that the number of records in the job history information is smaller, virtual individual IDs which uniquely specify individual products but are not IDs borne, like RFIDs, by the products are assigned by the number of virtual individual IDs equivalent to a difference between the number of records in the job history information and the value of the quantity acquired from the EDI message.

Further, according to the present invention, there is provided a fourth job history complementing method in which when the processing of estimating a job history included in the first job history complementing method is carried out, processing of notifying an EDI customer of the fact that the quantity is different from the number of records is carried out at the same time.

Further, according to the present invention, there is provided a fifth job history complementing method in which the EDI message employed in the first, second, third, and fourth job history complementing methods contains: at least an information category that specifies a type of job indicated by the EDI message; an accepting side code that uniquely specifies an accepting side of a deal relevant to the EDI message; an ordering side code that uniquely specifies an ordering side of the deal relevant to the EDI message; a deal number that uniquely specifies the deal relevant to the EDI message; a product code that uniquely specifies a type of products relevant to the job indicated by the EDI message; a quantity of the products relevant to the job indicated by the EDI message; and a date/time on which the job indicated by the EDI message has been performed. The job history information of the individual level employed in the first, second, third, and fourth job history complementing methods contains: at least an individual ID that uniquely specifies each product; a product code that uniquely specifies the type of product; a site ID that uniquely specifies a site where the job that results in the job history information has been performed; a date/time on which the job that results in the job history information has been performed; a work type that specifies from what job the job history information originates; a deal number that uniquely specifies a deal relevant to the job that results in the job history information; a probability at which the product of the individual ID has existed during the job that results in the job history information.

Other problem and a solving means thereof that are disclosed in the present application will be apparent from Description of the Preferred Embodiments and appended drawings.

According to the present invention, job history information concerning a deal can be complemented. Assume that an ID that uniquely specifies a deal (hereinafter called a deal number) is assigned to a deal in relation to a series of jobs that starts with ordering succeeded by shipment and receipt, testing, acceptance inspection, and payment. As long as one of two companies that make a business deal with each other through EDI can acquire job history information while discriminating individual products from one another, history information on a job that has been performed by a company incapable of acquiring information on a level on which the individual products can be discriminated from one another (hereinafter called an individual level) can be complemented on the individual level by utilizing business deal information transferred through EDI (hereinafter called an EDI message). Therefore, a range of a job history capable of being searched can be expanded with respect to a certain type of products. In addition, when a quantity of products is varied in the course of the deal because of a missing product or the like, not only an error is returned to an EDI customer but also a probability value or a virtual ID is utilized in order to estimate and complement a job history. Thus, search of the job history can be realized.

### BRIEF DESCRIPTION OF THE DRAWINGS

The present invention will become fully understood from the detailed description given hereinafter and the accompanying drawings, wherein:

FIG. 1 is an overall configuration diagram of a system concerning an embodiment of the present invention;

FIG. 2 is a diagram showing a table structure of an EDI message database in a storage device of job history complementing equipment in which records obtained when the number of products shipped from one merchant and the number of products received by the other merchant are squared with each other are registered;

FIG. 3 is a diagram showing a table structure of the EDI message database in the storage device of the job history complementing equipment in which records obtained when the number of products received by the other merchant is smaller than the number of products shipped from the merchant are registered;

FIG. 4 is a diagram showing a table structure of the EDI message database in the storage device of the job history complementing equipment in which records obtained when the number of products received by the other merchant is larger than the number of products shipped from the merchant are registered;

FIG. 5 is a diagram showing a table structure of a job history database in the storage device of the job history complementing equipment in which records available before a receipt history is complemented using a job history complementing program are registered;

FIG. 6 is a diagram showing a table structure of the job history database in the storage device of the job history complementing equipment in which records, which are available after the receipt history is complemented using the job history complementing program in a case where the number of products shipped from the merchant and the number of products received by the other merchant are square with each other, are registered;

FIG. 7 is a diagram showing a table structure of the job history database in the storage device of the job history complementing equipment in which records, which are available after the receipt history is complemented using the job history complementing program in a case where the number of products received by the other merchant is smaller than the number of products shipped from the merchant, are registered;

FIG. 8 is a diagram showing a table structure of the job history database in the storage device of the job history complementing equipment in which records, which are available after the receipt history is complemented using the job history complementing program in a case where the number of products received by the other merchant is larger than the number of products shipped from the merchant, are registered;

FIG. 9 is a diagram showing a table structure of a complementing processing decision database in the storage device of the job history complement apparatus;

FIG. 10 is a flowchart describing information reception processing;

FIG. 11 is a flowchart describing job history complementing processing; and

FIG. 12 is a flowchart describing job history estimation processing.

### DESCRIPTION OF THE PREFERRED EMBODIMENTS

Referring to the drawings, an embodiment of the present invention will be described below.

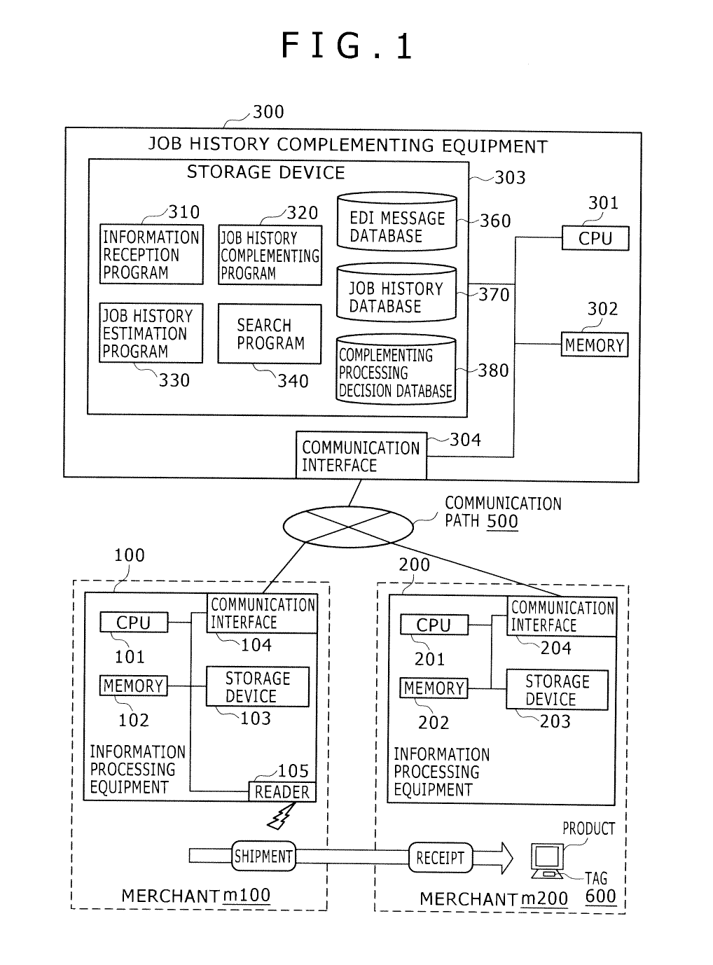

FIG. 1 is an overall configuration diagram of a system concerning the present embodiment. The system includes job history complementing equipment 300, information processing equipment 100 of at least one merchant m100 owing a reader (a reader that reads at least an individual ID from a tag, for example, a bar code reader, a two-dimensional code reader, or an radiofrequency ID (RFID) reader), information processing equipment 200 of at least one merchant m200 which does not own the reader, a tag 600 borne by at least one product, and a communication path 500. The communication path 500 links the job history complementing equipment 300, information processing equipment 100, and information processing equipment 200. The communication path 500 is realized with a communication path conformable to a certain standard, for example, a wired LAN or a wireless LAN.

The tag 600 is a medium in which at least an individual ID uniquely specifying a product, which bears the tag 600, on an individual level (a level on which individual products of the same type can be discriminated from one another) is stored, for example, a bar code, a two-dimensional cord, or an RFID tag.

The information processing equipment 100 is so-called computer equipment, for example, a personal computer. Using the information processing equipment 100, the merchant m100 manages a shipment history of products on the individual level, creates business deal information (hereinafter called an EDI message) which is transferred through electronic data interchange (EDI), on the basis of shipment history information, and transmits the shipment history information of the individual level and the EDI message (shipment) to the job history complementing equipment 300. The information processing equipment 100 includes at least a CPU 101, a memory 102, a storage device 103, a communication interface 104, and a reader 105. The reader 105 is, for example, a bar code reader, a two-dimensional code reader, or an RFID reader, and reads at least the individual ID from the tag 600. The communication interface 104 is an interface, for example, a wired LAN card or a wireless LAN card, and communicates with the job history complementing equipment 300 over the communication path 500. The storage device 103 is a device in which programs and data are stored, for example, a hard disk or a flash memory. The programs stored in the storage device 103 are read into the memory 102, and run by the CPU 101. Thus, various pieces of processing to be described later are executed.

The information processing equipment 200 is, for example, a personal computer. Using the information processing equipment 200, the merchant m200 manages a receipt history of products on a lot level (a level on which products can be distinguished in units of a type such as a product code), creates an EDI message (receipt) on the basis of receipt history information, and transmits the EDI message (receipt) to the job history complementing equipment 300. The information processing equipment 200 includes at least a CPU 201, a memory 202, a storage device 203, and a communication interface 204. The communication interface 204 is an interface, for example, a wired LAN card or a wireless LAN card, and communicates with the job history complementing equipment 300 over the communication path 500. The storage device 203 is a device in which programs and data are stored, for example, a hard disk or a flash memory. The programs stored in the storage device 203 are read into the memory 202, and run by the CPU 201. Thus, various pieces of processing to be described later are executed.

The job history complementing equipment 300 is, for example, a personal computer, and is provided with a job history of the individual level and an EDI message from the information processing equipment 100 or information processing equipment 200. Based on the pieces of information, the job history complementing equipment 300 produces and manages receipt history information on the individual level. The job history complementing equipment 300 includes at least a CPU 301, a memory 302, a storage device 303, and a communication interface 304. The communication interface 304 is an interface, for example, a wired LAN card or a wireless LAN card, and communicates with the information processing equipment 100 or information processing equipment 200 over the communication path 500. The storage device 303 is a device in which programs and data are stored, for example, a hard disk or a flash memory. As the programs, at least an information reception program 310, a job history complementing program 320, a job history estimation program 330, and a search program 340 are stored. As the data, at least an EDI message database 360, a job history database 370, and a complementing processing decision database 380 are stored.

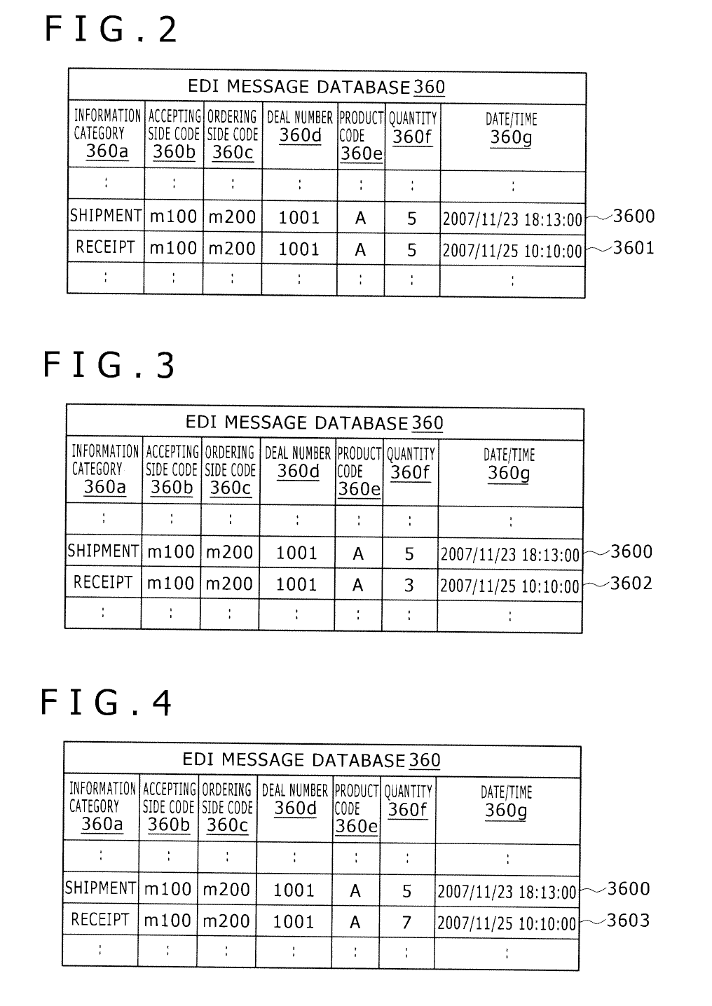

The EDI message database 360 is a database to be used to manage business deal information that is acquired from the information processing equipment 100 of the merchant m100 who owns a reader, or the information processing equipment 200 of the merchant m200 who does not own a reader, and that is transferred between the merchant m100 and merchant m200 through EDI. The structure of the EDI message database 360 will be described later in conjunction with FIG. 2, FIG. 3, and FIG. 4.

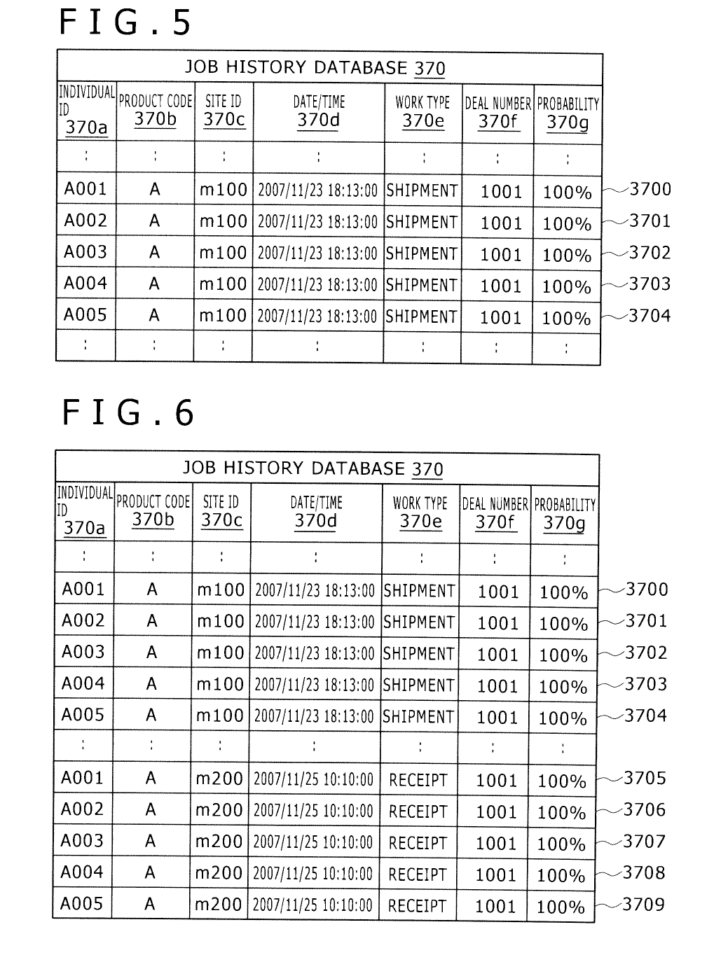

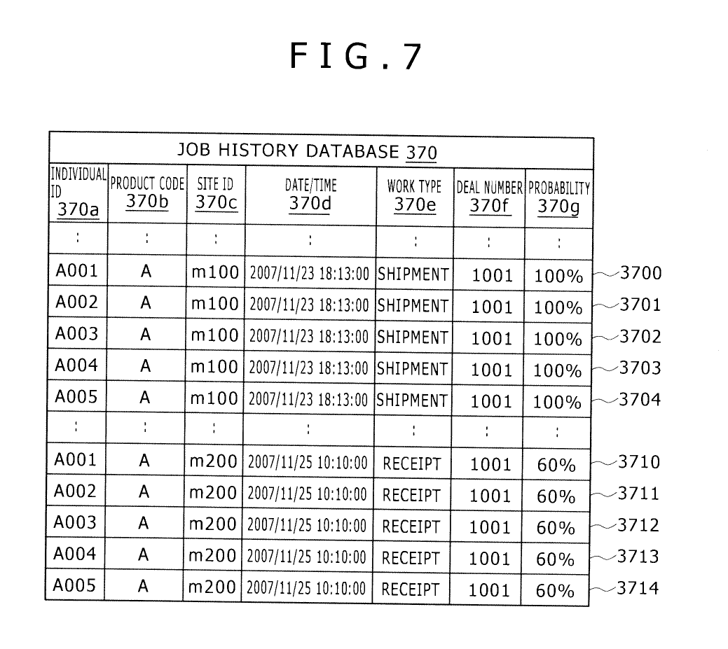

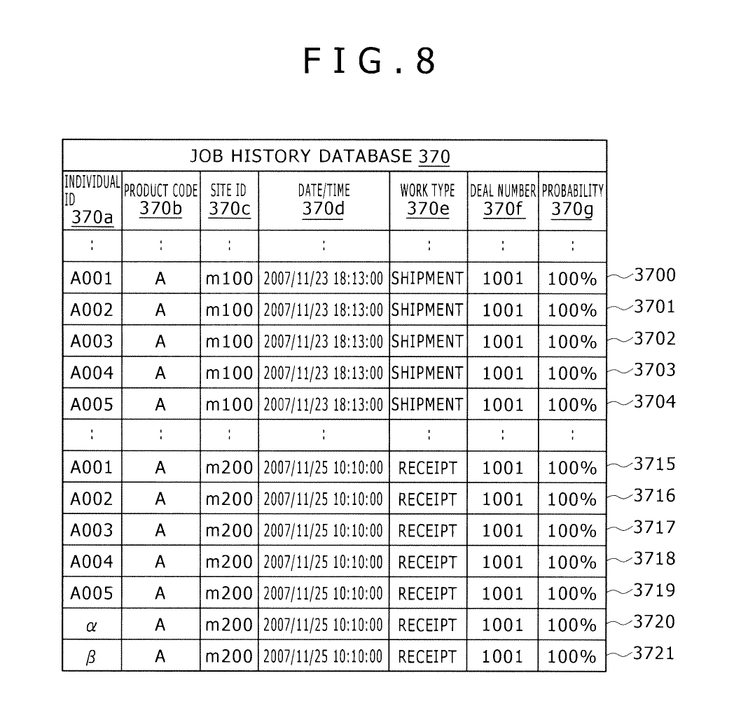

The job history database 370 is a database to be used to manage job history information concerning products which is acquired from the information processing equipment 100 of the merchant m100 who owns the reader or produced by the job history complementing program 320. The structure of the job history database 370 will be described later in conjunction with FIG. 5, FIG. 6, FIG. 7, and FIG. 8.

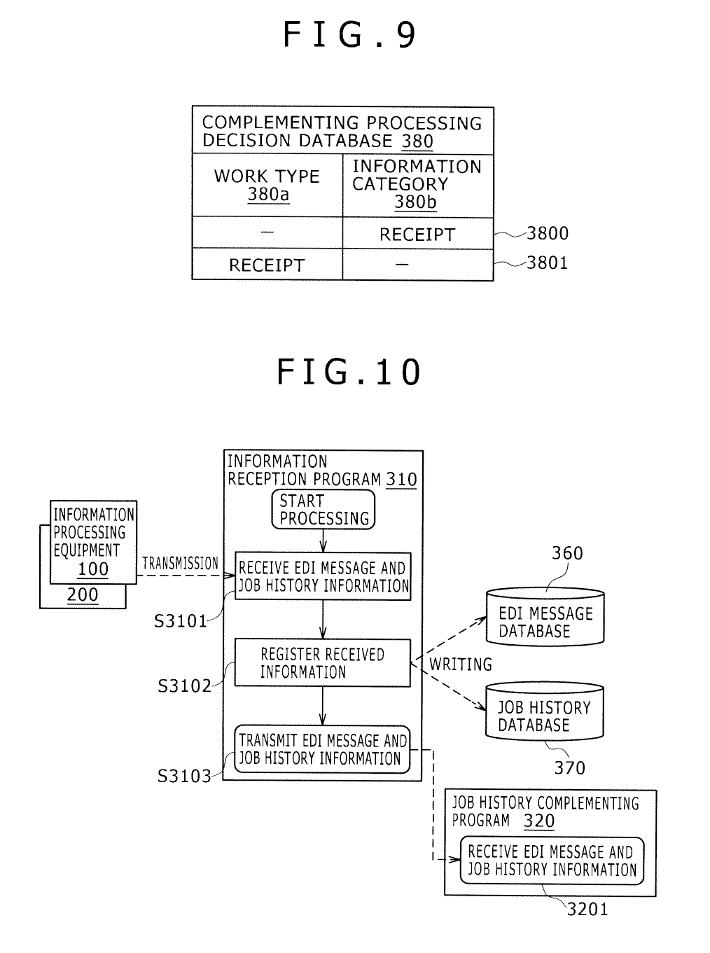

The complementing processing decision database 380 is a database to be used to manage information that has been set prior to use of the equipment and that is used as a trigger of job history complementing processing. The structure of the complementing processing decision database 380 will be described later in conjunction with FIG. 9.

The information reception program 310 is a program that after receiving the EDI message or job history information from the information processing equipment 100 or information processing equipment 200, registers data items in the EDI message database 360 or job history database 370, and transmits the data items to the job history complementing program 320. An information reception processing flow to be followed by the information reception program 310 will be described later in conjunction with FIG. 10.

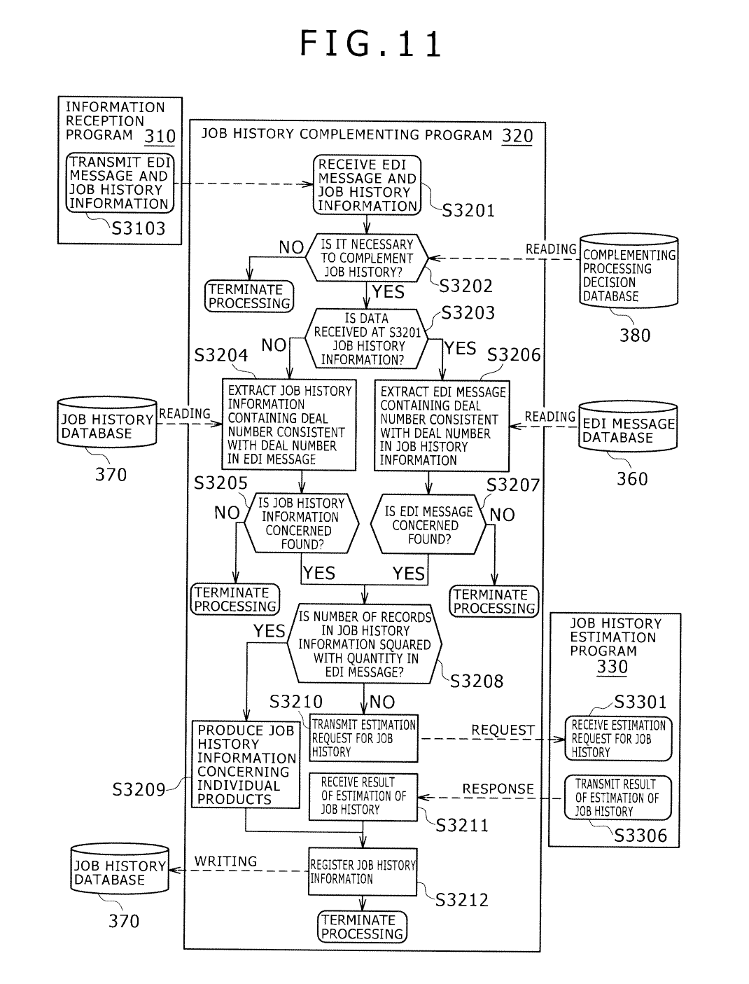

The job history complementing program 320 is a program that receives the EDI message or job history information sent from the information reception program 310, and produces and manages history information on a job, which has been performed by the merchant m200 incapable of acquiring information on the individual level, on the individual level on the basis of the received data items and the data items registered in the EDI message database 360 and job history database 370. A job history complementing processing flow to be followed by the job history complementing program 320 will be described later in conjunction with FIG. 11.

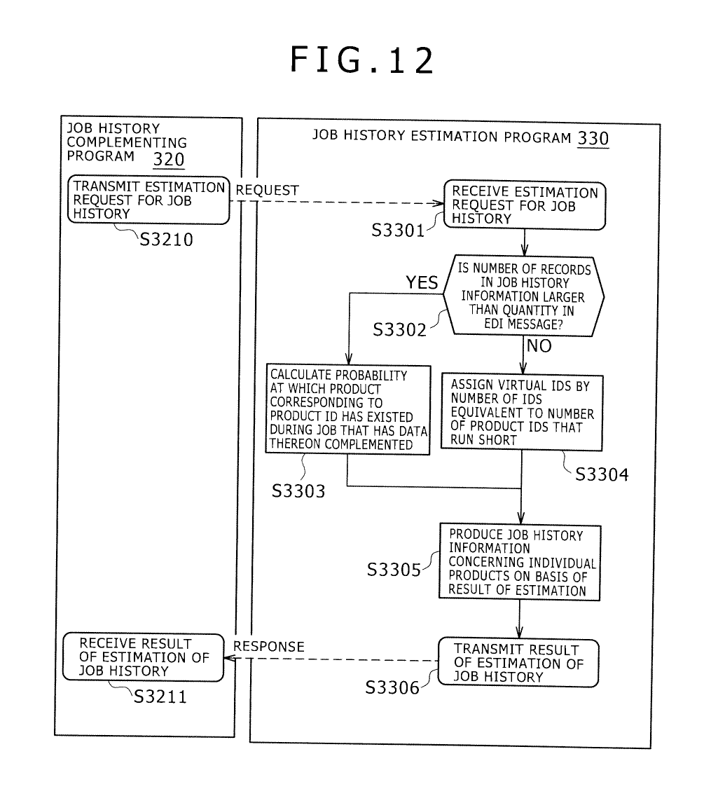

The job history estimation program 330 is a program that receives an estimation request concerning a job history from the job history complementing program 320, and providing the job history complementing program 320 with the results. A job history estimation processing flow to be followed by the job history estimation program 330 will be described later in conjunction with FIG. 12.

The search program 340 is a program that when receiving a search request concerning a job history from the merchant m100 or merchant m200, acquires records, which meet the requested conditions for search, from the job history database 370, and returns the records.

The programs stored in the storage device 303 are read into the memory 302 and run by the CPU 301, whereby the pieces of processing are executed.

In the system configuration shown in FIG. 1, a job of shipment and receipt is taken for instance. The system configuration can be applied to any of an ordering job, the shipment and receipt job, a testing job, an acceptance inspection job, and a payment job to which an ID uniquely specifying a deal is assigned as a feature of a turnaround deal.

In the system configuration shown in FIG. 1, the information processing equipment 100, information processing equipment 200, and job history complementing equipment 300 are shown independently of one another. Alternatively, the job history complementing equipment 300 may presumably be integrated into the information processing equipment 100 or information processing equipment 200.

FIG. 2, FIG. 3, and FIG. 4 show the structure of the EDI message database 360. FIG. 2 shows an example of an EDI message issued in a case where the number of products shipped from the merchant m100 is squared with the number of products received by the merchant m200. FIG. 3 shows an example of the EDI message issued in a case where the number of products received by the merchant m200 is smaller than the number of products shipped from the merchant m100. FIG. 4 shows an example of the EDI message issued in a case where the number of products received by the merchant m200 is larger than the number of products shipped from the merchant m100. The EDI message database 360 includes, as record fields, fields of at least an information category 360a, an accepting side code 360b, an ordering side code 360c, a deal number 360d, a product code 360e, a quantity 360f, and a date/time 360g.

In the field of the information category 360a, a code that specifies a type of job indicated by the EDI message is set (recorded).

In the field of the accepting side code 360b, a code that uniquely specifies an accepting side of a deal relevant to the EDI message is set (recorded). In the field of the ordering side code 360c, a code that uniquely specifies an ordering side of the deal relevant to the EDI message is set (recorded). In the field of the deal number 360d, a number that uniquely specifies the deal relevant to the EDI message is set (recorded). As for the number, over a series of jobs that starts with ordering succeeded by shipment and receipt, testing, acceptance inspection, and payment, the same ID is assigned in order to uniquely specify the deal.

In the field of the product code 360e, a code that uniquely specifies a type of products relevant to the job indicated by the EDI message is set (recorded). In the field of the quantity 360f, a quantity of the products relevant to the job indicated by the EDI message is set (recorded). In the field of the date/time 360g, a date/time on which the job indicated by the EDI message has been performed is set (recorded).

FIG. 5, FIG. 6, FIG. 7, and FIG. 8 show the structure of the job history database 370. FIG. 5 shows an example of job history information available before a receipt history is complemented by the job history complementing program 320. FIG. 6 shows an example of the job history information available after the receipt history is complemented in a case where the number of products shipped from the merchant m100 is squared with the number of products received by the merchant m200. FIG. 7 shows an example of the job history information available after the receipt history is complemented in a case where the number of products received by the merchant m200 is smaller than the number of products shipped from the merchant m100. FIG. 8 shows an example of the job history information available after the receipt history is complemented in a case where the number of products received by the merchant m200 is larger than the number of products shipped from the merchant m100. The job history database 370 includes, as record fields, fields of at least an individual ID 370a, a product code 370b, a site ID 370c, a date/time 370d, a work type 370e, a deal number 370f, and a probability 370g.

In the field of the individual ID 370a, an ID that uniquely specifies each product and is, for example, read from the tag 600 is set (recorded).

In the field of the product code 370b, a code that uniquely specifies the type of product specified by the individual ID 360a is set (recorded).

In the field of the site ID 370c, an ID that uniquely specifies a site where the job that results in the job history information has been performed is set (recorded). For example, an ID (m100) that uniquely specifies a manufacturer which has performed a shipment job, or an ID that uniquely specifies a factory of the manufacturer is set (recorded).

In the field of the date/time 370d, a date/time on which the job that results in the job history information has been performed is set (recorded).

In the field of the work type 370e, a work name signifying from what job the job history information originates is set (recorded). For example, if the job history information is produced for a shipment job, “shipment” is set (recorded). In the field of the deal number 370f, a number that uniquely specifies a deal relevant to the job that results in the job history information is set (recorded). In the field of the probability 370g, a probability value at which the product of the individual ID 370a has existed during the job that results in the job history information is set (recorded).

Next, referring to FIG. 9, the structure of the complementing processing decision database 380 will be described below. The complementing processing decision database 380 includes, as record fields, fields of at least a work type 380a and an information category 380b.

In the field of the work type 380a, if information that triggers job history complementing processing is job history information, a work name signifying from what job the job history information originates is set (recorded).

In the field of the information category 380b, if information that triggers job history complementing processing is an EDI message, a code that specifies the type of job indicated by the EDI message is set (recorded).

FIG. 10 is a flowchart describing information reception processing. According to the processing flow, the information reception processing program 310 registers an EDI message or job history information, which is received from the information processing equipment 100 of the merchant m100 who owns a reader or the information processing equipment 200 of the merchant m200 who does not own the reader, in the EDI message database 360 or job history database 370, and transmits the EDI message or job history information to the job history complementing program 320.

The processing flow is initiated on the occasion that the information reception program 310 receives the EDI message or job history information from the information processing equipment 100 or information processing equipment 200 (S3101).

Once the processing flow is initiated, the information reception program 310 registers the EDI message or job history information, which is received at step S3101, in the EDI message database 360 or job history database 370 (3102).

The information reception program 310 transmits the EDI message or job history information, which is received at step S3101, to the job history complementing program 320 (S3103).

FIG. 11 is a flowchart describing job history complementing processing. According to the processing flow, the job history complementing program 320 produces history information on a job, which has been performed by the merchant m200 incapable of acquiring information on the individual level, on the individual level on the basis of the EDI message or job history information received from the information reception program 310, and the data items registered in the EDI message database 360 and job history database 370, and registers the history information in the job history database 370.

The processing flow is initiated on the occasion that the job history complementing program 320 receives the EDI message or job history information from the information reception program 310 (S3201).

When the processing flow is initiated, the job history complementing program 320 acquires an information category from the EDI message received at step S3201, and uses the information category as a search key to extract the associated record from the complementing processing decision database 380. Otherwise, the job history complementing program 320 acquires a work type from the job history information received at step S3201, and uses the work type as the search key to extract the associated record from the complementing processing decision database 380. If the associated data is not found, the processing is terminated. If the associated data is found, the processing proceeds to step S3203. For example, when the data received at step S3201 is the EDI message and the content of the EDI message is a record 3601 shown in FIG. 2 and registered at step S3102, a record 3602 shown in FIG. 3, or a record 3603 shown in FIG. 4, the complementing processing decision database 380 is searched with the value “receipt” of the information category 360a as a search key. Thus, a record 3800 in FIG. 9 is acquired, and the processing is passed to step S3203.

At step S3203, if the information received at step S3201 is the EDI message alone but is not the job history information, the job history complementing program 320 passes e processing to step 3204. If the information is the job history information, the job history complementing program 320 passes the processing to step S3206.

At step S3204, the job history complementing program 320 acquires a deal number from the EDI message identified at step S3203, and extracts job history information from the job history database 370 using the deal number as a search key. For example, assume that the data received at step S3201 is the EDI message, and that the content of the EDI message is the record 3601 shown in FIG. 2 and registered at step S3102, the record 3602 shown in FIG. 3, or the record 3603 shown in FIG. 4. In this case, since the value of the deal number 360d is 1001, five records 3700, 3701, 3702, 3703, and 3704 shown in FIG. 5 and registered in the job history database 370 are extracted.

At step S3205, if the results of the search are not found, the job history complementing program 320 terminates the processing. If the results of the search are found, the processing is passed to step 3208.

In contrast, at step S3206, the job history complementing program 320 acquires a deal number from job history information identified at step S3203, and extracts an EDI message from the EDI message database 360 using the deal number as a search key.

At step S3207, if the results of the search are not found, the job history complementing program 320 terminates the processing. If the results of the search are found, the processing is passed to step S3208.

At step S3208, if the number of records in job history information extracted at step S3204 is squared with the value of a quantity acquired from an EDI message identified at step S3203, or if the number of records in job history information identified at step S3203 is squared with the value of a quantity acquired from an EDI message extracted at step S3206, the job history complementing program 320 passes the processing to step S3209. If the number of records is not squared with the value, the processing is passed to step S3210.

At step S3209, the job history complementing program 320 produces job history information concerning individual products in relation to individual IDs specified in the job history information, which is extracted at step D3204 or identified at step S3203, on the basis of the values of an information category, an ordering side code, an accepting side code, a deal number, a product code, a quantity, and a date/time which are specified in the EDI message which is identified at step S3203 or extracted at step S3206. For example, assume that the data received at step S3201 is the EDI message, and the content of the EDI message is the record 3601 shown in FIG. 2 and registered at step S3102, five records 3705, 3706, 3707, 3708, and 3709 whose values of an individual ID 370a, a product code 370b, a site ID 370c, a date/time 370d, a work type 370e, a deal number 370f, and a probability 370g are as shown in FIG. 6 are produced.

At step S3210, the job history complementing program 320 notifies the job history estimation program 330 of the EDI message, which is identified at step S3203 or extracted at step S3206, and the job history information that is extracted at step S3204 or identified at step S3203, thus requests the job history estimation program 330 to estimate a job history, and receives the result of the estimation (S3211).

The job history complementing program 320 registers the jog history information, which is produced at step S3209 or S3211, in the job history database 370 (S3212).

FIG. 12 is a flowchart describing job history estimation processing. According to the processing flow, the job history estimation program 330 estimates a job history on the individual level on the basis of an EDI message and job history information received from the job history complementing program 320, and transmits the job history to the job history complementing program 320.

The processing flow is initiated on the occasion that the job history estimation program 330 is notified of the EDI message and job history information by the job history complementing program 320, and thus receives an estimation request for a job history concerning individual products (S3301).

When the processing flow is initiated, the job history estimation program 330 compares the number of records in the job history information with the value of a quantity acquired from the EDI message. If the number of records in the job history information is larger, the processing is passed to step S3303. If the number of records in the job history information is smaller, the processing is passed to step S3304.

At step S3303, the job history estimation program 330 uses the number of records in the job history information and the value of the quantity acquired from the EDI message to calculate a probability value at which the product corresponding to each of the individual IDs contained in the job history information has existed during a job which has history information thereon complemented. For example, assume that the data received at step S3201 is an EDI message, and the content of the EDI message is the record 3602 shown in FIG. 3 and registered at step S3102. In this case, three out of products corresponding to five individual IDs (A001, A002, A003, A004, and A005) in the job history information have been received. Therefore, 60% is calculated as a probability value at which each of the products corresponding to the individual IDs has existed during the receipt job.

In contrast, at step S3304, the job history estimation program 330 assigns virtual individual IDs, which uniquely specify individual products but are not IDs borne, like the tags 600, by the products, by the number of IDs equivalent to a difference between the number of records in the job history information and the value of the quantity acquired from the EDI message. For example, assume that the data received at step S3201 is an EDI message and the content of the EDI message is the record 3603 shown in FIG. 4 and registered at step S3102. In this case, since the number of records in the job history information is smaller by two than the value of the quantity acquired from the EDI message, “α” and “β” are assigned as the virtual individual IDs.

Based on the probability value calculated at step S3303 or the virtual IDs assigned at step S3304, the job history estimation program 330 produces job history information concerning individual products in relation to individual IDs in the job history information, which is notified at step S3301, on the basis of the values of the information category, accepting side code, ordering side code, deal number, product code, quantity, and date/time contained in the EDI message (S3305). For example, assume that the data received at step S3201 is an EDI message, and the content of the EDI message is the record 3601 shown in FIG. 2 and registered at step S3102. In this case, five records 3710, 3711, 3712, 3713, and 3714 each having the values of the individual ID 370a, product code 370b, site ID 370c, date/time 370d, work type 370e, deal number 370f, and probability 370g shown in FIG. 7 are produced. Assuming that the data received at step S3201 is the EDI message and the content of the EDI message is the record 3603 shown in FIG. 4 and registered at step S3102, seven records 3715, 3716, 3717, 3718, 3719, 3720, and 3721 having the values of the individual ID 370a, product code 370b, site ID 370c, date/time 370d, work type 370e, deal number 370f, and probability 370g shown in FIG. 8 are produced.

The job history estimation program 330 transmits the job history information produced at step S3305 to the job history complementing program 320 (S3306).

The mode in which the present invention is implemented has been concretely described so far. However, the present invention is not limited to the mode but can be modified in various manners without a departure from the gist.

For example, the system configuration shown in FIG. 1 is such that the information processing equipment 100 of the merchant m100 which is a shipping source includes the reader 105. Alternatively, the information processing equipment 200 of the merchant m200 which is a receiving side or shipping destination may include the reader. In this case, the job history complementing equipment 300 complements shipment history information on the basis of an EDI message (shipment) received from the merchant m100 and receipt history information received from the merchant m200.

In the present embodiment, at step S3208, if the number of records in job history information is not squared with the value of a quantity acquired from an EDI message, the job history estimation program 330 estimates job history information. Thereafter, when products for which a deal is made are received, if the fact that a product becomes missing during transportation is discovered, a probability value may be re-calculated or re-estimation may be carried out by utilizing the job history estimation program 330.

In the present embodiment, if the number of records in job history information is not squared with the value of a quantity acquired from an EDI message, estimation processing of steps S3303 and S3304 is carried out. Concurrently with the estimation processing, the fact that the quantity is different from the number of records may be notified an EDI customer.

As described so far, according to the present embodiment, an ID (hereinafter called a deal number) which uniquely specifies a deal is assigned to a deal that involves a series of jobs which starts with ordering succeeded by shipment and receipt, testing, acceptance inspection, and payment. In this case, if one of two companies that make a business deal with each other through EDI can acquire job history information while discriminating individual products from one another, history information on a job which is performed by the other company incapable of acquiring information on a level on which the individual products can be discriminated from one another (hereinafter called an individual level) can be complemented on the individual level by utilizing business deal information (hereinafter called an EDI message) to be transferred through EDI. Therefore, for a certain type of products, the range of a job history capable of being searched can be expanded. In addition, even if a quantity of products is varied in the course of the deal because of a missing product or the like, not only an error is returned to an EDI customer but also a probability value or a virtual ID is utilized in order to estimate and complement a job history. Thus, search of the job history can be realized.

What is claimed is:

1. A job history complementing method for complementing job history information concerning a deal which a plurality of companies makes with each other and to which a deal number that uniquely specifies the deal is assigned,
wherein first information processing equipment which is utilized by a first company executes the steps of:
receiving job history information which signifies a history in the deal concerning individual products that are objects of the deal, and an EDI message which is business deal information to be transferred between second information processing equipment and third information processing equipment through electronic data interchange (EDI), from the second information processing equipment utilized by a second company out of the second company and a third company which are included in the plurality of companies and have a business relationship;
receiving the EDI message from the third information processing equipment; and
using the EDI messages which are received from the second information processing equipment and third information processing equipment, and the received job history information to calculate a shortage in the job history information concerning individual products which is acquired over a series of jobs involved in the deal.

2. The job history complementing method according to claim 1, further comprising the steps of:
comparing a quantity of the individual products contained in the received job history information with a quantity contained in the received EDI message; and
if the result of the comparison demonstrates that the quantities are inconsistent with each other, estimating a job history.

3. The job history complementing method according to claim 2, wherein the step of estimating a job history includes a step of:
if the result of the comparison demonstrates that the quantity in the job history information is larger, calculating a probability value at which each of products corresponding to individual IDs in the job history information has existed during a job that has history information thereon complemented.

4. The job history complementing method according to claim 2, wherein the step of estimating a job history includes a step of:
if the result of the comparison demonstrates that the quantity in the job history information is smaller, producing virtual individual IDs, with which individual products are identified, by the number of IDs equivalent to a difference between the quantity in the job history information and the quantity contained in the EDI message.

5. The job history complementing method according to claim 2, wherein the step of estimating a job history includes a step of:
transmitting information, which signifies the fact that the quantities are different from each other, to the second or third information processing equipment.

6. The job history complementing method according to claim 1,
wherein the EDI message contains:
an information category that specifies a type of job indicated by the EDI message;
an accepting side code that uniquely specifies an accepting side of a deal relevant to the EDI message;
an ordering side code that uniquely specifies an ordering side of the deal relevant to the EDI message;
a deal number that uniquely specifies the deal relevant to the EDI message;
a product code that uniquely specifies a type of products relevant to the job indicated by the EDI message;
a quantity of the products relevant to the job indicated by the EDI message; and
a date/time on which the job indicated by the EDI message has been performed, and
wherein the job history information contains:
an individual ID with which the individual product is identified;
a product code with which the type of individual product is identified;
a site ID with which a site where a job that results in the job history information has been performed is identified;
a date/time on which the job that results in the job history information has been performed;
a work type that specifies from what job the job history information originates;
a deal number with which a deal relevant to the job that results in the job history information is identified; and
a probability at which the product of the individual ID has existed during the job that results in the job history information.

7. Job history complementing equipment that is utilized by a first company in order to implement a job history complementing method for complementing job history information concerning a deal which a plurality of companies makes with each other and to which a deal number that uniquely specifies the deal is assigned, comprising:
a unit that receives job history information, which signifies a history in the deal concerning individual products that are objects of the deal, and an EDI message, which is business deal information to be transferred between second information processing equipment and third information processing equipment through EDI, from the second information processing equipment utilized by a second company out of the second company and a third company which are included in the plurality of companies and have a business relationship;
a unit that receives the EDI message from the third information processing equipment; and
a unit that calculates a shortage in the job history information concerning the individual products, which the first information processing equipment has acquired over a series of jobs involved in the deal, using the EDI messages received from the second information processing equipment and third information processing equipment, and the received job history information.

8. The job history complementing equipment according to claim 7, further comprising:
a unit that compares a quantity of the individual products contained in the received job history information with a quantity contained in the received EDI message; and
a unit that if the result of the comparison demonstrates that the quantities are inconsistent with each other, estimates a job history.

9. The job history complementing equipment according to claim 8, wherein if the result of the comparison demonstrates that the quantity in the job history information is larger, the unit that estimates a job history calculates a probability value at which each of products corresponding to individual IDs in the job history information has existed during a job that has history information thereon complemented.

10. The job history complementing equipment according to claim 8, wherein if the result of the comparison demonstrates that the quantity in the job history information is smaller, the unit that estimates a job history produces virtual individual IDs, with which individual products are identified, by the number of IDs equivalent to a difference between the quantity in the job history information and the quantity contained in the EDI message.

11. The job history complementing equipment according to claim 8, wherein the unit that estimates a job history transmits information, which signifies the fact that the quantities are different from each other, to the second or third information processing equipment.

12. The job history complementing equipment according to claim 7,
wherein the EDI message contains:
an information category that specifies a type of job indicated by the EDI message;
an accepting side code that uniquely specifies an accepting side of a deal relevant to the EDI message;
an ordering side code that uniquely specifies an ordering side of the deal relevant to the EDI message;
a deal number that uniquely specifies the deal relevant to the EDI message;
a product code that uniquely specifies a type of products relevant to the job indicated by the EDI message;
a quantity of the products relevant to the job indicated by the EDI message; and
a date/time on which the job indicated by the EDI message has been performed, and
wherein the job history information contains:
an individual ID with which the individual product is identified;
a product code with which the type of individual product is identified;
a site ID with which a site where the job that results in the job history information has been performed is identified;
a date/time on which the job that results in the job history information has been performed;
a work type that specifies from what job the job history information originates;
a deal number that uniquely specifies a deal relevant to the job that results in the job history information; and
a probability at which the product of the individual ID has existed during the job that results in the job history information.

13. A job history complementing system for complementing job history information concerning a deal which a plurality of companies makes with each other and to which a deal number that uniquely specifies the deal is assigned, comprising:
job history complementing equipment including:
a unit that receives job history information, which signifies a history in the deal concerning individual products that are objects of the deal, and an EDI message, which is business deal information to be transferred between second information processing equipment and third information processing equipment through EDI, from the second information processing equipment utilized by a second company out of the second company and a third company that are included in the plurality of companies and have a business relationship,
a unit that receives the EDI message from the third information processing equipment, and
a unit that calculates a shortage in the job history information concerning the individual products, which the job history complementing equipment that is first information processing equipment has acquired over a series of jobs involved in the deal, using the EDI messages received from the second information processing equipment and third information processing equipment, and the received job history information;
the second information processing equipment;
the third information processing equipment; and
one or more tags in each of which an individual ID with which the individual product is identified is recorded.
